(19) United States
(12) Patent Application Publication
(10) Pub. No.: US 2008/0028651 A1
(43) Pub. Date: Feb. 7, 2008

(54) Post-Disaster Notification System

(75) Inventors: Joan Katz, Boynton Beach, FL (US); Phillip D. Mrozinski, Boca Raton, FL (US); Rosemary Mullany, Delray Beach, FL (US); David Steiger, Boynton Beach, FL (US); Barbara Simkins, Boynton Beach, FL (US); Harv Tasch, Lake Worth, FL (US); Vicki Green, Delray Beach, FL (US)

Correspondence Address: RUDEN, MCCLOSKY, SMITH, SCHUSTER & RUSSELL, P.A., 222 LAKEVIEW AVE, SUITE 800, WEST PALM BEACH, FL, 33401-6112, US

(73) Assignee: Area Agency on Aging Palm Beach/Treasure Coast, Inc.

(21) Appl. No.: 11/754,732

(22) Filed: May 29, 2007

Related U.S. Application Data
(60) Provisional application No. 60/809,264, filed on May 30, 2006.

(51) Int. Cl. G09F 23/00

(52) U.S. Cl. 40/599

(57) ABSTRACT

A post-disaster alert system for prominently displaying whether or not a person within a particular residence needs assistance includes a display such as a door hanger that can be arranged to be easily viewed from the outside of the residence. The display includes at least a signal that a person within the residence needs assistance or that no one in the residence needs assistance. Emergency response personnel or others can use the display to quickly evaluate the assistance needs of a large number of residences in a given area.

### CROSS-REFERENCE TO RELATED APPLICATIONS

The present application claims the priority of U.S. provisional patent application ser. No. 60/809,264 filed on May 30, 2006.

### FIELD OF THE INVENTION

This invention relates generally to the field of post-disaster notification systems. More particularly, the invention relates to a system for alerting emergency response personnel of the status of persons in a residence using a display device which can be easily arranged to display a signal that assistance is needed or not needed.

### BACKGROUND

In the wake of a disaster such as a hurricane, earthquake, tsunami, flood, or terrorist attack, many people in the affected area are left without adequate food, water, shelter, communication means or medication. As the recent spate of hurricanes in the southeastern United States has shown, this situation can rapidly escalate into a massive life-threatening situation—especially for the elderly and infirm. To address this, during or after the disaster, emergency response workers such as police, firemen, paramedics, public health officers, military personnel, and volunteers go door-to-door checking on residents to see if they require assistance.

Unfortunately, this has proven to be a very tedious process complicated by the difficultly in differentiating those residences housing someone needing assistance from those residences that do not require assistance. The time wasted in checking up on residents that clearly do not need help results in a delay in providing assistance to those that urgently require help—sometimes with dire consequences.

### SUMMARY

The invention relates to the development of devices and methods for quickly informing emergency response personnel or others such as neighbors or relatives of the status of persons in a residence during or after a disaster. In the invention, a display is arranged on or near a residence to provide an easily visible signal indicating whether a resident needs assistance or not. As one example of a system of the invention, a resident is provided with a door hanger (e.g., by wide spread distribution such as by mass mailing or inclusion in the newspaper) which has a first side printed with “OK,” and a second side printed with “HELP!” During or after a disaster, the resident places the door hanger with the appropriate side facing away from the residence (e.g., pointing toward the street). In evaluating an area, emergency response personnel can quickly determine which residences need assistance (i.e., those whose door hangers are arranged to display HELP!) and which do not (i.e., those whose door hangers are arranged to display OK).

In some embodiments of the system, the display is capable of presenting other information such as: whether the residence has been evacuated, what assistance is needed (water, food, or medication), where the evacuated residents can be contacted, the number of persons residing in the residence, etc. To facilitate its interpretation by emergency response personnel, the display can be color coded (e.g., green for OK and red for HELP!), and/or include a reflective coating (to light up when hit with a flash light beam). In other embodiments, other information can be printed on the display such as emergency telephone numbers, information for preparing for a disaster, and logos/advertising for companies sponsoring the system.

Accordingly, the invention features a post-disaster alert device for prominently displaying whether or not a person within a particular residence needs assistance. The device features a display that includes at least a first signal indicating that a person within the residence needs assistance and a second signal indicating that no one in the residence needs assistance. In one variation, the device is a door hanger having a first side including the first signal (e.g., a printed request for assistance) and a second side including the second signal (a printed indication that no assistance is requested). To facilitate reading of the display, the first side can be marked with a distinctive color (e.g., red) and the second side can marked with another distinctive color easily discernible from the first (e.g., green).

In another aspect, the invention features a method for alerting emergency response personnel as to whether or not a person within a particular residence needs assistance. The method includes the steps of: (a) prior to the occurrence of a disaster, providing the person with a post-disaster alert display device having at least a first signal indicating that some one within the residence needs assistance and a second signal indicating that no one in the residence needs assistance; and (b) after the disaster, placing the display device in a location where it can be easily seen by someone outside the residence. In one variation of the method, the device is placed on a door of the residence.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In the case of conflict, the present specification, including any definitions will control. In addition, the particular embodiments discussed below are illustrative only and not intended to be limiting.

Other features and advantages of the invention will be apparent from the following detailed description, and from the claims.

### BRIEF DESCRIPTION OF THE DRAWINGS

FIG. 1 is an illustration of one side of a door hanger of a system of the invention.

FIG. 2 is an illustration of the opposite side of the door hanger of FIG. 1.

### DETAILED DESCRIPTION

The invention encompasses a system for alerting emergency response personnel of the status of persons in a residence using a display which can be arranged to provide a prominent signal of whether a resident needs assistance or is okay. The below described preferred embodiments illustrate various adaptations of this system. Nonetheless, from the description of these embodiments, other aspects of the invention can be made and/or practiced based on the description provided below.

### Post-disaster Notification Device

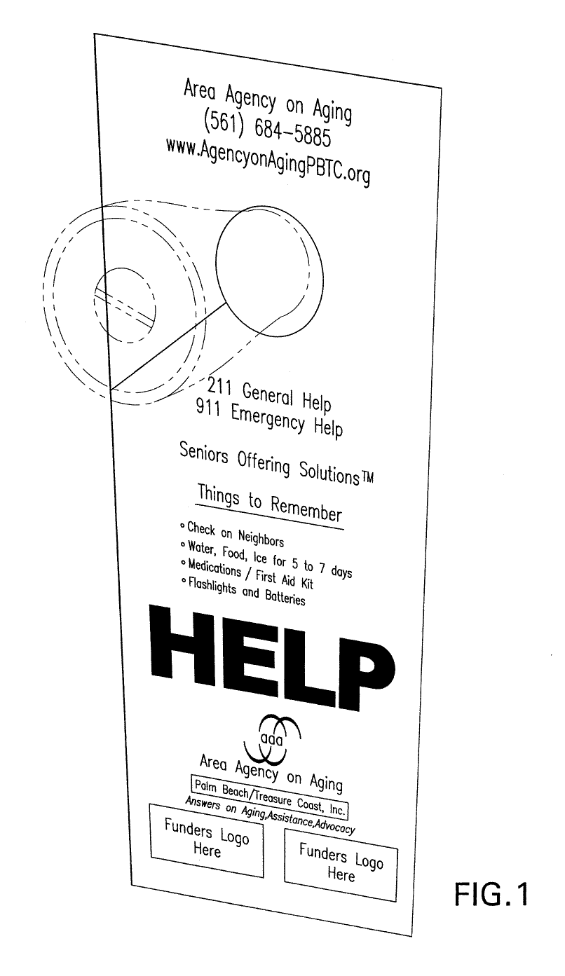

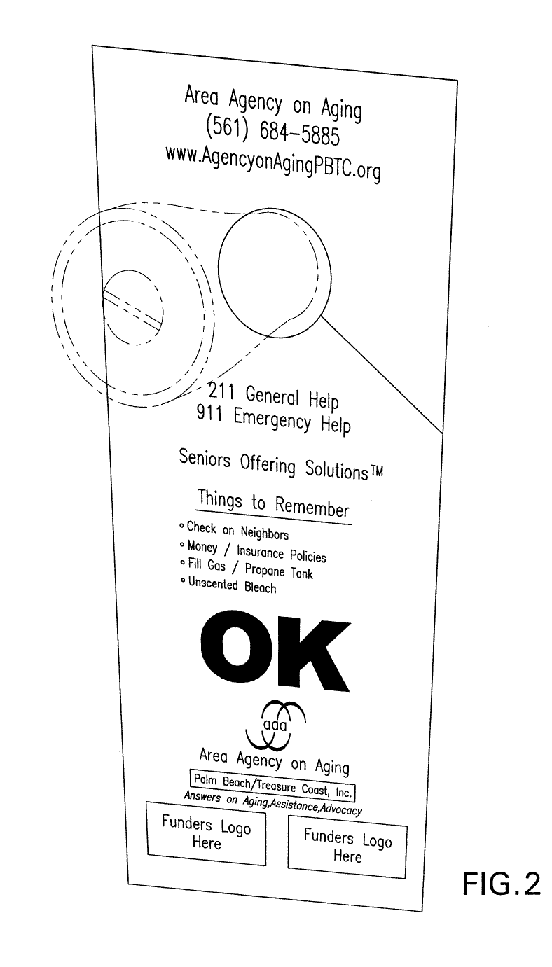

Referring now to FIGS. 1 and 2, a display device for post-disaster notification is arranged as a door hanger having a first side, a second side, and an aperture with slit for affixing the device on a door knob. The display device can be made of any suitable material and can be of any size or shape appropriate for hanging from a door knob and being visible from a distance (e.g., a 4×7 inch rectangle). Examples of materials from which the device can be made include paper (preferred for cost and printability), coated paper (preferred as for both low cost, durability, and weather resistance), and plastic (preferred for durability and weather resistance). The device might also include an adhesive (e.g., a repositionable adhesive) for affixing the device to the residence. In alternate embodiments, the aperture with slit of the device might be replaced by an attachment means, such as a rubber band, string, cable, adhesive, plastic tie, hook, rope, or tape for affixing the device to the residence, and in particular, for affixing the device to a door knob of the residence. FIG. 1 shows the first side of the device which has printed thereon a request for assistance (i.e., “HELP”), phone numbers for general and emergency help, a reminder list of disaster-related items, and logos/advertising space. FIG. 2, the reverse side of the device of FIG. 1, has printed thereon an indication that no assistance is requested (i.e., “OK”), phone numbers for general and emergency help, a reminder list of disaster-related items, and logos/advertising space.

In other embodiments of the invention, the display device includes other information or space for adding information which might be useful to emergency response personnel or others. For example, the display device might include an indication that all persons in the residence have evacuated the residence (which could be indicated by a check box on the side of the device shown in FIG. 2), that a particular type of assistance is needed (e.g., a checklist requesting food, water, medical assistance, or a particular medication), contact information (e.g., where the residents have evacuated to, cellular telephone numbers, contact information for relatives, etc.), and the number of persons remaining in the residence. To facilitate its interpretation by emergency response personnel, the display can be marked with a discernible identifier such as a particular color (e.g., green/fuchsia for OK and red/chartreuse for HELP!). Preferred versions of the device of the invention include a reflective coating that appears to light up upon being hit with a beam of light, e.g., from a flash light.

### Post-disaster Notification Method

The invention further includes a method for quickly informing emergency response personnel or others such as neighbors or relatives of the status of persons in a residence during or after a disaster. In the method of the invention, a display is arranged on or near a residence to provide an easily visible signal indicating whether a resident needs assistance or not. As one example of a system of the invention, a resident is provided with a door hanger (e.g., by wide spread distribution such as by mass mailing or inclusion in the newspaper) which has a first side printed with “OK,” and a second side printed with “HELP!” During or after a disaster, the resident places the door hanger with the appropriate side facing away from the residence (e.g., pointing toward the street). In evaluating an area, emergency response personnel can quickly determine which residences need assistance (i.e., those whose door hangers are arranged to display HELP!) and which do not (i.e., those whose door hangers are arranged to display OK).

### Other Embodiments

While the above specification contains many specifics, these should not be construed as limitations on the scope of the invention, but rather as examples of preferred embodiments thereof. Many other variations are possible. Accordingly, the scope of the invention should be determined not by the embodiments illustrated, but by the appended claims and their legal equivalents.

What is claimed is:

1. An emergency notification device for prominently displaying whether or not a person within a particular residence needs assistance, comprising:
a display capable of being affixed to a door of the residence comprising:
(a) a first signal that comprises printed indicia indicating that the person within the residence requires assistance; and
(b) a second signal that comprises printed indicia indicating that no one in the residence requires assistance.

2. The emergency notification device of claim 1, wherein the display further comprises attachment means for affixing the display to the residence or to a surface near the residence.

3. The emergency notification device of claim 1, wherein the display comprises a substrate capable of being affixed to a door or other surface; and
wherein the substrate comprises a first side that incorporates said first signal and a second side that incorporates said second signal.

4. The emergency notification device of claim 3, wherein the display further comprises an aperture with a slit for affixing the display on a door knob.

5. The emergency notification device of claim 1, wherein the printed indicia comprises the word “HELP.”

6. The emergency notification device of claim 1, wherein the first signal and the second signal each comprise a different color for indicating the assistance needs of the person in the residence.

7. The emergency notification device of claim 1, wherein at least one of the first signal and the second signal comprises a reflective material.

8. The emergency notification device of claim 1, wherein the display is constructed from a material selected from one or more of the following: paper, coated paper, and plastic.

9. The emergency notification device of claim 8, wherein the material from which the display is constructed is coated paper.

10. The emergency notification device of claim 1, wherein the display further comprises printed contact information for emergency assistance.

11. The emergency notification device of claim 1, wherein the display further comprises a printed list of items that should be purchased or acquired before a disaster event.

12. The emergency notification device of claim 1, wherein the display further comprises at least one sponsor advertisement or sponsor logo.

13. The emergency notification device of claim 1, wherein the second signal of the display further comprises printed information related to the type of assistance required by the person in the residence;
wherein the information comprises a checklist requesting food, water, medical assistance, or a particular medication.

14. The emergency notification device of claim 1, wherein the display further comprises designated space for entering contact information for persons who have evacuated the residence.

15. The emergency notification device of claim 6, wherein the color of the first signal is red and the color of the second signal is green.

16. A post-disaster alert device comprising:
a door hanger display for hanging on a door knob, comprising:
(a) a first side comprising printed indicia and a first color which indicate that a person in a residence requires assistance;
(b) a second side comprising printed indicia and a second color that is different from the first color which indicate that the person in the residence does not require assistance; and
(c) an aperture for affixing the door hanger display on the door knob.

17. The post-disaster alert device of claim 16, wherein at least one of the first side and the second side includes a reflective coating.

18. A method for alerting emergency response personnel or a rescuer as to whether a person in a residence requires emergency assistance, said method comprising the steps of:
(i) prior to a disaster event, providing a person with a post-disaster alert display device comprising a substrate that comprises a first signal indicating that someone within a residence requires assistance and a second signal indicating that no one in the residence requires assistance; and
(ii) after the disaster event, placing the post-disaster alert display device in a location where either the first signal or the second signal of the display device can be easily seen by someone outside of the residence so as to indicate whether the person in the residence requires assistance
wherein the signal displayed is selected based upon the emergency assistance needs of persons in the residence.

19. The method of claim 18, further comprising the step of affixing the post-disaster alert display device to a front, street-side door of the residence to alert emergency response personnel or a rescuer as to whether any person in the residence requires emergency assistance.

20. The method of claim 18, further comprising the step of printing or otherwise entering contact information in a designated space on the post-disaster alert display device for persons who have evacuated the residence.
